(19) United States
(12) Patent Application Publication
(10) Pub. No.: US 2026/0146108 A1
(43) Pub. Date: May 28, 2026

(54) POLYMER PARTICLE PRODUCING DEVICE, POLYMER PARTICLE PRODUCING METHOD, PROGRAM, AND STORAGE MEDIUM

(71) Applicant: Panasonic Intellectual Property Management Co., Ltd., Osaka (JP)

(72) Inventors: TAICHI NAKAMURA, Osaka (JP); JUNJI HOSOKAWA, Osaka (JP); SHINNOSUKE AKIYAMA, Osaka (JP)

(21) Appl. No.: 19/393,656

(22) Filed: Nov. 19, 2025

(30) Foreign Application Priority Data
Nov. 28, 2024 (JP) 2024-207593

(51) Int. Cl. C08F 2/32; C08F 2/01

(52) U.S. Cl. CPC C08F 2/32; C08F 2/01; C08F 2400/02

(57) ABSTRACT

A polymer particle producing device for producing polymer particles by mixing an aqueous phase, a surfactant, and a monomer phase to prepare an oil-in-water emulsion and performing a monomer polymerization reaction using the prepared oil-in-water emulsion is provided. The device includes a supply unit including a flow path for supplying a first aqueous phase and a plurality of flow paths for supplying a surfactant, a monomer phase, and an initiator; a mixing unit disposed on a downstream side of the supply unit and including a first mixer that merges the first aqueous phase, the surfactant, and the monomer phase to prepare an emulsion and transfers the emulsion to a downstream side of the first mixer, and a second mixer that merges the emulsion and the initiator to generate a polymerization liquid and transfers the polymerization liquid to a downstream side of the second mixer; a reaction unit that is disposed on a downstream side of the mixing unit and causes a monomer polymerization reaction using the polymerization liquid; and a flow path for supplying a second aqueous phase to the reaction unit.

### BACKGROUND

### 1. Technical Field

The present disclosure relates to a device and a method for producing polymer particles, and specifically relates to a device and a method for producing polymer particles by an emulsion polymerization method.

### 2. Description of the Related Art

Polymer particles are widely used in the automobile industry, electronic devices, and the like. For example, polymer particles used in paints and the like are desired to have a small average particle size and a uniform particle size distribution.

As a method for producing polymer particles, an emulsion polymerization method is known. In the emulsion polymerization method, a monomer is dispersed in an aqueous phase together with a surfactant to prepare an oil-in-water emulsion, and a monomer polymerization reaction is performed using the obtained emulsion, whereby polymer particles can be obtained. Conventionally, a monomer polymerization reaction is performed in a batch method. In the batch method, it may be difficult to control the temperature in the reaction vessel to be uniform and the reactants to be uniformly mixed, and there has been a problem that the batch method is not suitable for mass production.

In recent years, a device called a microreactor that causes a reaction in a minute space has been used for producing polymer particles. A microreactor is a small reactor that synthesizes a target substance by causing a raw material to flow through a fine tubular flow path and to cause a flow chemical reaction in the flow path, and has excellent performance in fluid mixing, temperature control, and residence time control. The production of polymer particles using a microreactor is disclosed in, for example, Patent Document 1.

### CITATION LIST

### Patent Literature

PTL 1: Unexamined Japanese Patent Publication No. 2015-71772

### SUMMARY

In order to achieve the above object, a polymer particle producing device according to an aspect of the present disclosure for producing polymer particles by mixing an aqueous phase, a surfactant, and a monomer phase to prepare an oil-in-water emulsion and performing a monomer polymerization reaction using the prepared oil-in-water emulsion is provided. The device includes: a supply unit including a flow path for supplying a first aqueous phase and a plurality of flow paths for supplying a surfactant, a monomer phase, and an initiator; a mixing unit disposed on a downstream side of the supply unit and including a first mixer that merges the first aqueous phase, the surfactant, and the monomer phase to prepare an emulsion and transfers the emulsion to a downstream side of the first mixer, and a second mixer that merges the emulsion and the initiator to generate a polymerization liquid and transfers the polymerization liquid to a downstream side of the second mixer; a reaction unit that is disposed on a downstream side of the mixing unit and causes a monomer polymerization reaction using the polymerization liquid; and a flow path for supplying a second aqueous phase to the reaction unit.

In addition, in order to achieve the above object, a polymer particle producing method according to an aspect of the present disclosure is a method for generating polymer particles, including: producing an oil-in-water emulsion by joining a first aqueous phase, a surfactant, and a monomer phase in a flow path; generating a polymerization liquid by joining the produced oil-in-water emulsion and an initiator, and subjecting the produced polymerization liquid to a monomer polymerization reaction in a reaction unit; and supplying a second aqueous phase to the reaction unit.

In order to achieve the above object, a program according to an aspect of the present disclosure causes a processor to adjust an amount of an aqueous phase to be introduced into the reaction unit based on the detected characteristic amount in the polymer particle producing method.

In addition, in order to achieve the above object, a recording medium according to an aspect of the present disclosure is non-transitory computer-readable for storing the program.

### BRIEF DESCRIPTION OF THE DRAWINGS

FIG. 1 is a block diagram schematically illustrating a polymer particle producing step according to an exemplary embodiment of the present disclosure;

FIG. 2 is a schematic view illustrating a configuration example of a polymer particle producing device according to an exemplary embodiment of the present disclosure;

FIG. 3 is a block diagram schematically illustrating a configuration example of a control device of the polymer particle producing device of FIG. 2; and

FIG. 4 is a flowchart illustrating an aqueous phase supply adjustment process in polymer particle production according to a first embodiment of the present disclosure.

### DETAILED DESCRIPTIONS

In the method for producing polymer particles using the microreactor disclosed in PTL 1, polymerization of the radically polymerizable monomer proceeds in the microflow path, and nuclear formation and nuclear growth of fine particles continuously proceed while flowing. The steep heat of reaction generated by continuous nuclear formation and nuclear growth may change the particle size of the fine particles to be synthesized. In the production of polymer particles using a microreactor, there is still room for improvement in the conventional producing device and production method from the viewpoint of stably synthesizing particles having a desired particle size.

Therefore, the present disclosure solves the above-described conventional problems, and an object thereof is to provide a device and a method for producing polymer particles capable of improving the stability of particle size control.

According to a first aspect of the present disclosure, there is provided a polymer particle producing device for producing polymer particles by mixing an aqueous phase, a surfactant, and a monomer phase to prepare an oil-in-water emulsion and performing a monomer polymerization reaction using the prepared oil-in-water emulsion, the device including: a supply unit including a flow path for supplying a first aqueous phase and a plurality of flow paths for supplying a surfactant, a monomer phase, and an initiator; a mixing unit disposed on a downstream side of the supply unit and including a first mixer that merges the first aqueous phase, the surfactant, and the monomer phase to prepare an emulsion and transfers the emulsion to a downstream side of the first mixer, and a second mixer that merges the emulsion and the initiator to generate a polymerization liquid and transfers the polymerization liquid to a downstream side of the second mixer; a reaction unit that is disposed on a downstream side of the mixing unit and causes a monomer polymerization reaction using the polymerization liquid; and a flow path for supplying a second aqueous phase to the reaction unit.

According to this aspect, the stability of particle size control can be improved in the production process of polymer particles.

According to a second aspect of the present disclosure, there is provided the polymer particle producing device according to the first aspect, further including: a detection device that is disposed on a downstream side of the second mixer and detects a characteristic amount of the polymerization liquid; and an adjustment device that adjusts an amount of an aqueous phase to be introduced into the reaction unit based on the detected characteristic amount.

According to a third aspect of the present disclosure, there is provided the polymer particle producing device according to the second aspect, further including a control device, in which the control device includes: a processor; and a storage device that stores an instruction to be executed by the processor, the instruction calculates a correction amount with respect to a flow rate of supplying the aqueous phase to be introduced into the reaction unit based on the characteristic amount detected by the detection device, and the adjustment device adjusts a flow rate for supplying the first aqueous phase or a flow rate for supplying the second aqueous phase based on the calculated correction amount.

According to a fourth aspect of the present disclosure, there is provided the polymer particle producing device according to the third aspect, in which the instruction further includes operating the adjustment device to adjust the flow rate of supplying the first aqueous phase or the second aqueous phase based on the calculated correction amount.

According to a fifth aspect of the present disclosure, there is provided the polymer particle producing device according to a fourth aspect, in which the instruction includes: operating the adjustment device to adjust the flow rate for supplying the first aqueous phase based on the calculated correction amount when a change amount of the detected characteristic amount with respect to a predetermined reference value is equal to or more than a first reference value and less than a second reference value; and operating the adjustment device to adjust the flow rate for supplying the second aqueous phase based on the calculated correction amount when the change amount is equal to or more than the second reference value, and the first reference value and the second reference value are preset adjustment reference values, and the second reference value is larger than the first reference value.

According to a sixth aspect of the present disclosure, there is provided the polymer particle producing device according to any one of the second to fifth aspects, in which the characteristic amount is absorbance or viscosity of the polymerization liquid.

According to a seventh aspect of the present disclosure, there is provided the polymer particle producing device according to any one of the first to sixth aspects, in which the first mixer and the second mixer are configured by tubular flow paths, and an inner diameter of each of the tubular flow paths ranges from 0.1 mm to 10 mm, inclusive. According to an eighth aspect of the present disclosure, there is provided the polymer particle producing device according to any one of the first to seventh aspects, in which the reaction unit includes a reaction tank, and the monomer polymerization reaction is allowed to proceed in the reaction tank.

According to a ninth aspect of the present disclosure, there is provided a polymer particle producing method, including: producing an oil-in-water emulsion by joining a first aqueous phase, a surfactant, and a monomer phase in a flow path; generating a polymerization liquid by joining the produced oil-in-water emulsion and an initiator, and subjecting the produced polymerization liquid to a monomer polymerization reaction in a reaction unit; and supplying a second aqueous phase to the reaction unit.

According to a tenth aspect of the present disclosure, there is provided the polymer particle producing method according to the ninth aspect, further including: detecting a characteristic amount of the polymerization liquid; and adjusting an amount of an aqueous phase to be introduced into the reaction unit based on the detected characteristic amount.

According to an eleventh aspect of the present disclosure, there is provided the polymer particle producing method according to the tenth aspect, in which adjusting the amount of the aqueous phase to be introduced into the reaction unit based on the detected characteristic amount includes: calculating a correction amount with respect to a flow rate of supplying the aqueous phase to be introduced into the reaction unit based on the detected characteristic amount; and operating an adjustment device to adjust a flow rate for supplying the first aqueous phase or a flow rate for supplying the second aqueous phase based on the calculated correction amount.

According to a twelfth aspect of the present disclosure, there is provided the polymer particle producing method according to the eleventh aspect, in which adjusting an amount of an aqueous phase to be introduced into the reaction unit based on the detected characteristic amount includes: operating the adjustment device to adjust the flow rate for supplying the first aqueous phase based on the calculated correction amount when a change amount of the detected characteristic amount with respect to a predetermined reference value is equal to or more than a first reference value and less than a second reference value; and operating the adjustment device to adjust the flow rate for supplying the second aqueous phase based on the calculated correction amount when the change amount is the second reference value or more, and the first reference value and the second reference value are preset adjustment reference values, and the second reference value is larger than the first reference value.

According to a thirteenth aspect of the present disclosure, there is provided a program for causing a processor to adjust an amount of an aqueous phase to be introduced into the reaction unit based on the detected characteristic amount in the polymer particle producing method according to the eleventh or twelfth aspect.

According to a fourteenth aspect of the present disclosure, there is provided a non-transitory computer-readable storage medium storing the program according to the thirteenth aspect.

Note that by appropriately combining discretionary exemplary embodiments among the various exemplary embodiments described above, the effects of the respective exemplary embodiments can be achieved.

Hereinafter, exemplary embodiments will be described in detail with appropriate reference to the drawings. However, unnecessarily detailed description may be omitted. For example, a detailed description of an already well-known matter and a duplicated description of substantially the same configuration may be omitted. This is to avoid an unnecessarily redundant description below and to facilitate understanding of a person skilled in the art.

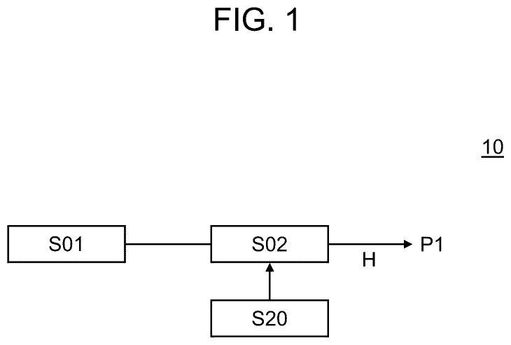

A polymer particle producing method and a polymer particle producing device according to an exemplary embodiment of the present disclosure will be described with reference to FIGS. 1 to 4. The accompanying drawings and the following description are provided for those skilled in the art to fully understand the present disclosure, and are not intended to limit the subject matter described in the claims in any way. Furthermore, in each of the drawings, elements are illustrated exaggeratedly in order to facilitate the description. In the drawings, substantially the same members are denoted by the same reference marks.

### EXEMPLARY EMBODIMENT

### <<Polymer Particle Producing Step>>

A flow of a polymer particle producing step according to an exemplary embodiment of the present disclosure will be described with reference to FIG. 1. FIG. 1 is a block diagram schematically illustrating polymer particle producing step 10 according to an exemplary embodiment of the present disclosure.

The polymer particle production according to the present exemplary embodiment is performed based on an emulsion polymerization method. In polymer particle producing step 10 by the emulsion polymerization method illustrated in FIG. 1, polymer particles P1 are synthesized through emulsification step S01 and polymerization step S02.

In emulsification step S01 according to the present exemplary embodiment, a monomer constituting the target polymer particles P1, an aqueous phase, and a surfactant are joined in a flow path to prepare an oil-in-water type emulsion. At this time, the solution containing each raw material is transferred by the flow path, and the prepared emulsion is transferred to polymerization step S02 by the flow path.

Next, in polymerization step S02, the prepared oil-in-water emulsion and the water-soluble initiator are mixed to generate a polymerization liquid, and the monomer polymerization reaction is performed in a reaction unit using the generated polymerization liquid. At this time, the emulsion and the water-soluble initiator can be joined in the flow path. By decomposition of the water-soluble initiator, the monomer polymerization reaction is initiated to form fine particle nuclei. The reaction unit can include a reaction tank, and the monomer polymerization reaction can proceed under predetermined conditions in the reaction tank. The synthesized polymer particles P1 flow in direction H and are introduced into a recovery unit.

The polymer particle producing step 10 according to the present exemplary embodiment further includes aqueous phase supply adjustment process S20. Aqueous phase supply adjustment process S20 adjusts the amount of the aqueous phase introduced into the reaction unit during the monomer polymerization reaction in polymerization step S02. As a result, polymer particles P1 having a desired particle size can be stably synthesized. Aqueous phase supply adjustment process S20 will be described in detail later.

Next, raw materials used in the polymer particle producing step 10 will be described.

The monomer as a raw material for producing polymer particles is not particularly limited, and can be appropriately selected according to the purpose. Examples of the monomer applied to the preparation of the oil-in-water type emulsion may include a styrene-based monomer containing derivatives such as styrene and methylstyrene, an acrylic acid derivative, an acrylamide derivative, a methacrylic acid derivative, a methacrylic acid ester, and a methacrylamide derivative. In addition, other monomers such as phenylene, thiophene, fluorene, alkyl, sulfone, ether, and fluoride can also be used as long as the monomers are suitable for emulsion polymerization. As the monomer phase, one of them may be used alone, or two or more thereof may be used in combination.

The monomer may be diluted with an organic solvent or the like. As used herein, a “monomer phase” refers to a solution comprising a monomer and an organic solvent. The organic solvent used for diluting the monomer is not particularly limited as long as the raw material monomers are dissolved, and examples thereof include aliphatic hydrocarbon-based solvents such as n-hexane and n-octane, halogenated hydrocarbon-based solvents such as carbon tetrachloride, and aromatic hydrocarbon-based solvents such as toluene and xylene.

As used herein, an “aqueous phase” refers to a solution containing water and water-soluble components. In the present exemplary embodiment, for example, pure water or ion-exchanged water can be used as the aqueous phase.

The surfactant used in the emulsification step is not particularly limited, and may be, for example, any of an ionic surfactant, a nonionic surfactant, and a polymerizable surfactant.

As the ionic surfactant, for example, sodium dodecylbenzene sulfonate, sodium lauryl sulfate, sodium alkyl diphenyl ether disulfonate, sodium polyoxyethylene alkyl ether sulfate, or the like can be used as the anionic surfactant. As the cationic surfactant, for example, stearylbenzyldimethylammonium chloride, distearylbenzyldimethylammonium chloride, or the like can be used.

As the nonionic surfactant, for example, polyoxyethylene alkyl ether, polyoxyethylene alkylphenyl ether, polyoxyalkylene polyol, polypropylene glycol ethylene oxide adduct, or the like can be used.

As the polymerizable surfactant, for example, sodium alkylallyl sulfosuccinate, sodium (meth) acryloyl polyoxyalkylene sulfate, or the like can be used.

These may be used singly or in combination of two or more kinds thereof.

The water-soluble initiator used in the polymerization step is not particularly limited, and can be appropriately selected from various water-soluble radical polymerization initiators conventionally used in the monomer polymerization reaction according to the type of the raw material monomer and the like. As such a water-soluble initiator, for example, ammonium persulfate, potassium persulfate, or sodium persulfate can be used. In addition, water-soluble organic peroxides, water-soluble azo compounds, redox-based initiators, persulfates, and the like can also be used. These water-soluble initiators may be used singly or in combination of two or more kinds thereof. The polymerization initiator may be supplied as, for example, an aqueous solution.

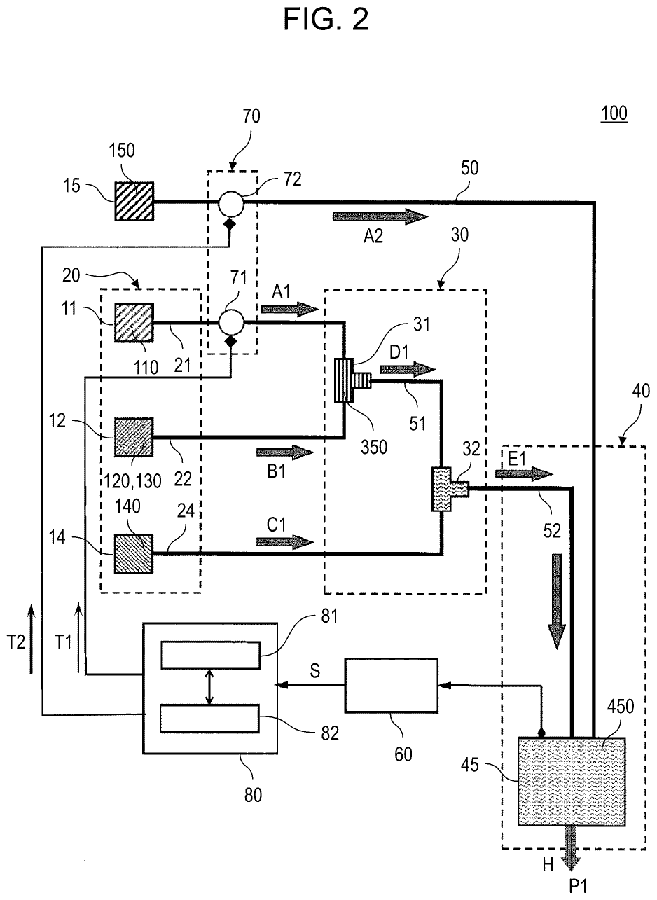

Polymer particle producing step 10 according to the exemplary embodiment of the present disclosure illustrated in FIG. 1 is performed using a polymer particle producing device. Hereinafter, a configuration of polymer particle producing device 100 according to an exemplary embodiment of the present disclosure will be described with reference to FIG. 2.

### <<Configuration of Polymer Particle Producing Device>>

FIG. 2 is a schematic view illustrating a configuration example of polymer particle producing device 100 according to an exemplary embodiment of the present disclosure. Polymer particle producing device 100 illustrated in FIG. 2 includes supply unit 20, mixing unit 30, reaction unit 40, and flow path 50. Polymer particle producing device 100 can be used for manufacturing polymer particles by an emulsion polymerization method.

Supply unit 20 of polymer particle producing device 100 illustrated in FIG. 2 is used to supply a raw material for generating polymer particles by a monomer polymerization reaction. Supply unit 20 can include a plurality of storage units 11, 12, and 14 for storing a solution in which a raw material is dissolved or dispersed in a solvent and a liquid feeding device (not illustrated) thereof, and flow paths 21, 22, and 24 connected to respective storage units 11, 12, and 14. In the present exemplary embodiment, for example, aqueous phase 110 in storage unit 11 is fed to flow path 21 by a liquid feeding device, surfactant 120 and monomer phase 130 in storage unit 12 are fed to flow path 22 by the liquid feeding device, and initiator 140 in storage unit 14 is fed to flow path 24 by the liquid feeding device. The liquid feeding device is not limited thereto, but can be configured by, for example, a syringe pump, a plunger pump, a diaphragm pump, a tube pump, a Mohno pump, a piezo pump, or the like (not illustrated).

Note that supply unit 20 is not limited to the configuration illustrated in FIG. 2, and the present disclosure is not limited to the type and number of fluids supplied by supply unit 20. For example, surfactant 120 and monomer phase 130 may be stored in separate storage units and sent to separate flow paths. Further, for example, depending on the application, in addition to the raw materials, further other fluids can be supplied together with the raw materials or separately.

Aqueous phase 110, surfactant 120, monomer phase 130, and initiator 140 supplied from supply unit 20 flow downstream in directions A1, B1, and C1, respectively, and are transferred to mixing unit 30 by flow paths 21, 22, and 24.

Mixing unit 30 includes first mixer 31 and second mixer 32, and in first mixer 31 and second mixer 32, a plurality of raw materials transferred by the flow path are merged. In the present exemplary embodiment, first mixer 31 and second mixer 32 are each configured by a tubular flow path having an inner diameter of 0.1 mm or more and 10 mm or less. As a result, first mixer 31 and second mixer 32 can cause the fluid to flow in the minute tubular flow path and promote the mixing of the plurality of raw materials.

The material of first mixer 31 and second mixer 32 is not particularly limited, and for example, stainless steel such as SUS304, SUS316, or SUS316L, a metal material such as Hastelloy, or a resin material such as PP, PFA, PTFE, PEEK, or PPS can be processed. First mixer 31 and second mixer 32 may have the same configuration or different configurations.

Aqueous phase 110, surfactant 120, and monomer phase 130 supplied by flow paths 21 and 22 are joined in first mixer 31 to form a mixed solution of the organic phase and the aqueous phase, thereby preparing oil-in-water type emulsion 350. Obtained emulsion 350 is transferred from first mixer 31 to the downstream side in direction DI by flow path 51, and merges with initiator 140 supplied by flow path 24 in second mixer 32 to generate a polymerization liquid. The generated polymerization liquid is transferred further downstream in direction E1 from second mixer 32, and is introduced into reaction unit 40.

Reaction unit 40 is disposed on the downstream side of mixing unit 30, and can include, for example, flow path 52 and reaction tank 45. In addition, reaction unit 40 can be provided with, for example, a stirring device, a gas introduction pipe, a heating device, and the like (not illustrated), and conditions suitable for the progress of the monomer polymerization reaction can be maintained in reaction tank 45. The polymerization reaction may take several hours, and by allowing the monomer polymerization reaction to proceed in the reaction tank, a sufficient reaction time can be secured and the device can be downsized. In the present exemplary embodiment, as illustrated in FIG. 2, in reaction unit 40, polymerization liquid 450 is introduced into reaction tank 45 from mixing unit 30 through flow path 52, the monomer polymerization reaction proceeds in reaction tank 45, and synthesized polymer particles P1 flow in direction H from reaction unit 40 and are transferred to the recovery unit on the downstream side.

Note that the present disclosure is not limited to allowing a monomer polymerization reaction to proceed using a reaction tank. For example, in reaction unit 40, the monomer polymerization reaction can also proceed in the flow path.

In the present exemplary embodiment, polymer particle producing device 100 further includes flow path 50, and flow path 50 is configured to supply aqueous phase 150 to reaction unit 40 during the monomer polymerization reaction. Aqueous phase 150 may be the same as or different from aqueous phase 110 supplied as a raw material. Aqueous phase 150 is fed from storage unit 15 by a liquid feeding device (not illustrated), flows in direction A2 along flow path 50, and is fed into reaction tank 45 of reaction unit 40.

Polymer particle producing device 100 according to the present exemplary embodiment supplies each raw material and aqueous phase 150 and transfers the fluid using the flow path. The flow path diameter of each flow path is not particularly limited, and can be configured according to the intended use such that the fluid flowing in the flow path can be easily transferred. For example, the flow path diameter can be 0.1 to 10 mm.

A material of each flow path of polymer particle producing device 100 is not particularly limited, and for example, an inorganic material such as glass, quartz, ceramics, or silicon, or a resin material such as a thermoplastic resin or a thermosetting resin can be used.

In reaction tank 45 of reaction unit 40, as the monomer polymerization reaction proceeds, nuclear formation and nuclear growth of fine particles proceed, and the reaction temperature in polymerization liquid 450 during the monomer polymerization reaction rises. As a result, the particle size of the polymer particles to be synthesized varies. polymer particle producing device 100 of the present disclosure can stabilize the reaction temperature in polymerization liquid 450 during the monomer polymerization reaction by introducing aqueous phase 150 into reaction unit 40 through flow path 50. As a result, polymer particle producing device 100 of the present exemplary embodiment can improve the stability of particle size control of the polymer particles to be synthesized.

### (Detection Device and Adjustment Device)

Polymer particle producing device 100 of the present exemplary embodiment can further include detection device 60 and adjustment device 70. Detection device 60 can detect a characteristic amount indicating the variation of the reaction temperature in polymerization liquid 450 in reaction unit 40 and monitor the variation of the reaction temperature of the polymerization liquid during the monomer polymerization reaction. Adjustment device 70 can adjust the amount of the aqueous phase introduced into reaction unit 40 based on the characteristic amount detected by detection device 60. The amount of the aqueous phase introduced into reaction unit 40 can be adjusted by detection device 60 and adjustment device 70 according to the variation of the reaction temperature in polymerization liquid 450 during the monomer polymerization reaction.

During the monomer polymerization reaction, the absorbance or viscosity of the polymerization liquid changes due to the variation of the reaction temperature in the polymerization liquid. Therefore, in the present exemplary embodiment, detection device 60 can be configured to detect the absorbance or viscosity of polymerization liquid 450 as the characteristic amount indicating the variation of the reaction temperature in polymerization liquid 450 during the monomer polymerization reaction.

For example, detection device 60 can include an absorbance measuring device (not illustrated) that detects the absorbance of polymerization liquid 450 in reaction unit 40. The absorbance measuring device includes, for example, a light source unit and a light receiving unit (not illustrated), and the light emitted from the light source unit irradiates polymerization liquid 450 in the monomer polymerization reaction, and the light receiving unit can detect the absorbance of polymerization liquid 450 by detecting light before entering polymerization liquid 450 and light after passing through polymerization liquid 450.

Furthermore, for example, detection device 60 can include a viscometer (not illustrated) that detects the viscosity of polymerization liquid 450 in reaction unit 40. The viscometer may be, for example, a vibration type viscometer, and the viscosity of polymerization liquid 450 can be detected by vibrating a vibrating piece in polymerization liquid 450 and measuring the viscous resistance force of polymerization liquid 450 received at that time.

As a measuring mechanism of the absorbance measuring device or the viscometer, a conventionally known configuration of the absorbance measuring device or the viscometer can be adopted, and further detailed description is omitted herein. Note that the present disclosure is not limited to the number of detection devices 60 arranged. One detection device 60 may be provided, or a plurality of detection devices 60 may be provided.

The present disclosure is not limited to the position where detection device 60 is disposed. When emulsion 350 and initiator 140 join in second mixer 32 of the mixing unit, a monomer polymerization reaction is started to form fine particle nuclei. Detection device 60 may be disposed downstream of second mixer 32, and for example, detection device 60 may be disposed in reaction tank 45 of reaction unit 40 or may be disposed in the flow path downstream of second mixer 32.

Note that the configuration of the absorbance measuring device or the viscometer is one configuration example of detection device 60, and the present disclosure is not limited thereto. Detection device 60 is not limited to the configuration of the absorbance measuring device or the viscometer as long as it can detect the characteristic amount indicating the variation of the reaction temperature in polymerization liquid 450 during the monomer polymerization reaction.

Based on the characteristic amount of polymerization liquid 450 detected by detection device 60, a value of change in the characteristic amount of polymerization liquid 450 during the monomer polymerization reaction can be obtained with respect to the characteristic amount reference value of the polymerization liquid corresponding to the target reaction temperature. Here, the target reaction temperature is a reaction temperature in a polymerization liquid that can secure a desired particle size of polymer particles.

The correlation between the characteristic amount of polymerization liquid 450 and the amount of the aqueous phase introduced into reaction unit 40 can be verified in advance. As a result, it is possible to calculate a correction amount with respect to the flow rate of supplying the aqueous phase to reaction unit 40 so as to achieve the target reaction temperature of the polymerization liquid based on the detected change value of the characteristic amount of polymerization liquid 450.

In the present exemplary embodiment, the aqueous phase introduced into reaction unit 40 includes aqueous phase 110 supplied as a raw material and aqueous phase 150 supplied by flow path 50. In order to secure a desired particle size of the polymer particles, the flow rate for supplying aqueous phase 110 and/or aqueous phase 150 can be adjusted based on the calculated correction amount. Adjustment of the flow rate of aqueous phase 110 or aqueous phase 150 can be performed via adjustment device 70.

Adjustment device 70 of polymer particle producing device 100 is configured to adjust the amount of the aqueous phase introduced into reaction unit 40 based on the characteristic amount detected by detection device 60. Specifically, for example, but not limited to, adjustment device 70 may include a flow rate regulator including a flow rate regulator, a proportional control supply valve, and the like (not illustrated). In the present exemplary embodiment, adjustment device 70 includes flow rate regulators 71 and 72 as conceptually illustrated in FIG. 2. Based on the calculated correction amount, the flow rate for supplying aqueous phase 110 via flow rate regulator 71 can be adjusted, and the flow rate for supplying aqueous phase 150 via flow rate regulator 72 can be adjusted.

In the present exemplary embodiment, polymer particle producing device 100 may set the adjustment reference value in advance. When the change amount of the characteristic amount detected by detection device 60 is equal to or greater than the set adjustment reference value, the flow rate for supplying aqueous phase 110 or aqueous phase 150 can be adjusted. Here, the “change amount of characteristic amount” refers to an absolute value of a change value of the detected characteristic amount with respect to a predetermined characteristic amount reference value corresponding to a target reaction temperature of the polymerization liquid.

Furthermore, polymer particle producing device 100 of the present exemplary embodiment can selectively adjust the flow rate of the aqueous phase by setting different adjustment reference values for the flow rates of the aqueous phase supplied by the two flow paths. In the present exemplary embodiment, for example, a first reference value and a second reference value larger than the first reference value are set in advance as the adjustment reference value, and the flow rate for supplying aqueous phase 110 and the flow rate for supplying aqueous phase 150 can be selectively adjusted by comparing the change amount of the detected characteristic amount with the first reference value and the second reference value.

As illustrated in FIG. 2, in polymer particle producing device 100, aqueous phase 150 is directly introduced into reaction unit 40. Aqueous phase 110 joins a fluid containing surfactant 120, monomer phase 130, and initiator 140 in the flow path via mixing unit 30, and then is introduced into reaction unit 40. In order to uniformly mix various fluids while maintaining a predetermined mixing ratio in the flow path of the mixing unit, adjustment of the flow rate for supplying the fluids may be restricted. Therefore, in the present exemplary embodiment, for example, when the change amount of the detected characteristic amount is equal to or more than the first reference value and less than the second reference value, the flow rate for supplying aqueous phase 110 via flow rate regulator 71 can be adjusted based on the calculated correction amount. When the change amount of the detected characteristic amount is the second reference value or more, the flow rate for supplying aqueous phase 150 via flow rate regulator 72 can be adjusted based on the calculated correction amount.

In addition, flow rate regulator 71 and flow rate regulator 72 of adjustment device 70 can be configured to have different accuracy or flow rate adjustment ranges. By selecting flow rate regulator 71 or flow rate regulator 72 according to the change amount of the characteristic amount detected by detection device 60 and selectively adjusting the flow rate of aqueous phase 110 and the flow rate of aqueous phase 150, the amount of the aqueous phase introduced into reaction unit 40 can be more precisely adjusted. As a result, the reaction temperature in polymerization liquid 450 during the monomer polymerization reaction can be more stably maintained, and the stability of particle size control can be further improved.

In the present exemplary embodiment, the calculation of the correction amount and the operation of adjustment device 70 can be performed manually. In addition, in the polymer particle producing step, detection device 60 can detect the characteristic amount a plurality of times with respect to polymerization liquid 450 during the polymerization reaction, and can operate adjustment device 70 on the basis of each detected characteristic amount to repeatedly adjust the flow rate for supplying aqueous phase 110 or aqueous phase 150. In this way, polymer particle producing device 100 of the present exemplary embodiment can stably maintain the reaction temperature in polymerization liquid 450 during the monomer polymerization reaction, and can stably produce polymer particles having a desired particle size.

### (Control Device)

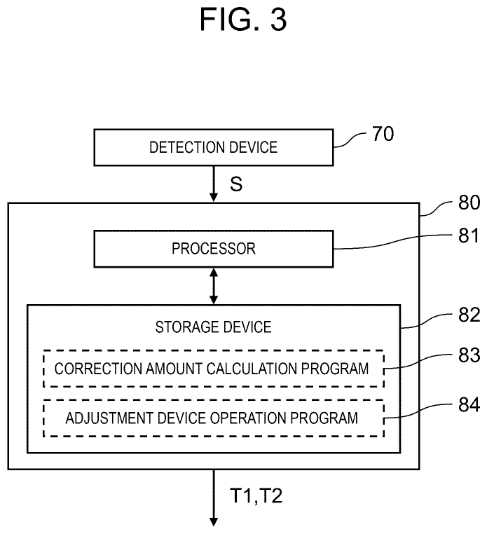

The polymer particle producing device 100 of the present disclosure can further include control device 80. During the monomer polymerization reaction, calculation of the correction amount and operation of adjustment device 70 can be executed using control device 80. At this time, as conceptually illustrated in FIG. 2, during the monomer polymerization reaction, detection device 60 can transmit, to control device 80, electric signal S according to the characteristic amount indicating the variation of the reaction temperature in polymerization liquid 450 during the monomer polymerization reaction. Control device 80 can control the regulation of the supply of aqueous phases 110 and 150 according to received electrical signal S. Hereinafter, a configuration of control device 80 will be described with reference to FIG. 3.

FIG. 3 is a block diagram schematically illustrating a configuration example of control device 80 of polymer particle producing device 100 in FIG. 2. Control device 80 includes processor 81 and storage device 82. Control device 80 realizes a predetermined function by processor 81 executing a command stored in storage device 82. A function of control device 80 may be configured only with hardware or may be realized by a combination of hardware and software. Control device 80 may include one or more processors 81.

Processor 81 can include, for example, a microcomputer, a CPU, an MPU, a GPU, a DSU, an FPGA, an ASIC, and the like. Processor 81 may be configured by a dedicated electronic circuit designed to implement a predetermined function.

Storage device 82 is a storage medium that stores a program and data for realizing a function of control device 80. Storage device 82 can be realized by a hard disk (HDD), an SSD, a RAM, a DRAM, a ferroelectric memory, a flash memory, a magnetic disk, or a combination of these, for example.

For example, control device 80 converts electric signal S received from detection device 60 into a digital signal by AD conversion, and performs signal processing as waveform data. The waveform data to which the signal processing is performed is stored in storage device 82.

Storage device 82 can store one or more programs. In the present exemplary embodiment, storage device 82 stores correction amount calculation program 83 and adjustment device operation program 84. When control device 80 is connected to a network, correction amount calculation program 83 and adjustment device operation program 84 may be downloaded from the network as necessary. During the monomer polymerization reaction, processor 81 can be caused to calculate the correction amount and operate the adjustment device by correction amount calculation program 83 and adjustment device operation program 84.

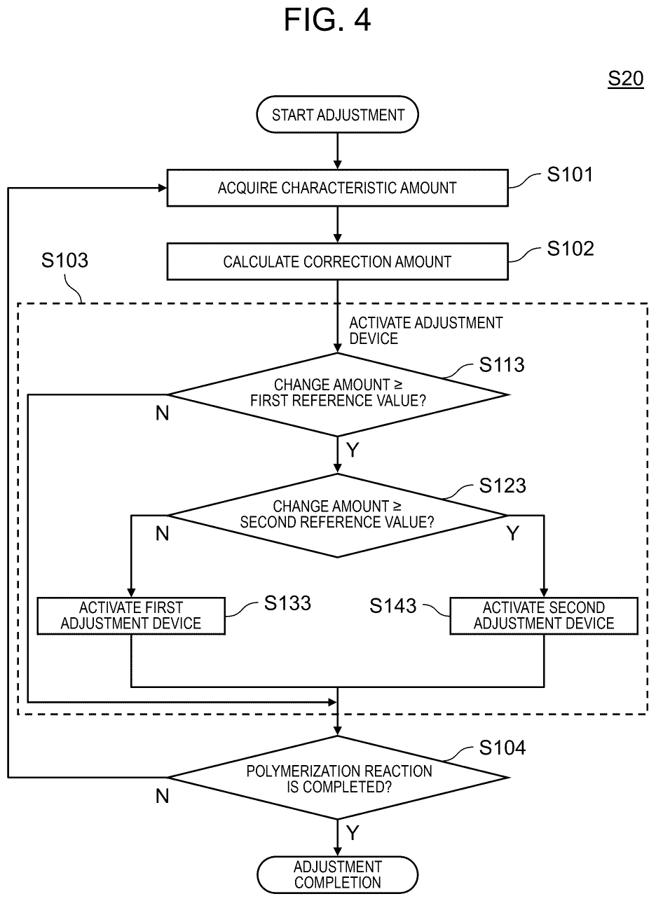

During the monomer polymerization reaction of polymer particle producing device 100, correction amount calculation program 83 and adjustment device operation program 84 are read from storage device 82, and processor 81 is caused to execute aqueous phase supply adjustment process S20, whereby the adjustment of the supply of aqueous phases 110 and 150 can be controlled. Aqueous phase supply adjustment process S20 will be described below with reference to FIG. 4 together with FIGS. 1 to 3.

### <<Aqueous Phase Supply Adjustment Process>>

FIG. 4 is a flowchart illustrating aqueous phase supply adjustment process S20 in polymer particle production according to the first embodiment of the present disclosure. By aqueous phase supply adjustment process S20, in the polymer particle producing step 10 illustrated in FIG. 1, the amount of the aqueous phase introduced into reaction unit 40 of polymer particle producing device 100 illustrated in FIG. 2 can be adjusted during the progress of the monomer polymerization reaction in polymerization step S02.

(1) First, in step S101, a characteristic amount is acquired. At this time, control device 80 can receive electric signal S transmitted from detection device 60. Electric signal S is an electric signal corresponding to the detection data of the characteristic amount indicating the variation of the reaction temperature in polymerization liquid 450 during the monomer polymerization reaction. In the present exemplary embodiment, the characteristic amount may be absorbance or viscosity of polymerization liquid 450. Transmission and reception of electric signal S may be realized by wired connection or wireless transfer.

(2) Next, in step S102, a correction amount is calculated. At this time, control device 80 reads correction amount calculation program 83 from storage device 82 and causes processor 81 to calculate the correction amount. When the correction amount is calculated, a value of change in the characteristic amount of polymerization liquid 450 during the monomer polymerization reaction can be obtained with respect to the characteristic amount reference value of the polymerization liquid corresponding to the target reaction temperature of the polymerization liquid capable of securing the desired particle size of the polymer particles using electric signal S received in S101. Furthermore, based on the obtained value of change in the characteristic amount, it is possible to calculate a correction amount with respect to the flow rate for supplying the aqueous phase to the reaction unit so as to achieve the target reaction temperature of the polymerization liquid.

In step S102, in order to calculate the correction amount with respect to the flow rate for supplying the aqueous phase to the reaction unit, data of the target reaction temperature of the polymerization liquid that can secure the desired particle size of the polymer particles, verification data regarding the correlation between the characteristic amount of polymerization liquid 450 and the amount of the aqueous phase introduced into the reaction unit, and the like can be used. These data can be obtained in advance and stored in storage device 82. Alternatively, in a case where control device 80 is connected to a network, these pieces of data may be downloaded from the network and used.

(3) Subsequently, in step S103, the adjustment device is operated. At this time, control device 80 reads adjustment device operation program 84 from storage device 82, and causes processor 81 to execute the operation of adjustment device 70. Control device 80 can operate adjustment device 70 to adjust the flow rate for supplying aqueous phase 110 or aqueous phase 150 based on the correction amount calculated in step S102.

In the present exemplary embodiment, aqueous phase supply adjustment process S20 may be provided with one or more adjustment reference values in advance. The adjustment reference value may be stored in storage device 82, or data may be downloaded from a network and used. Control device 80 can operate adjustment device 70 to compare the change amount of the characteristic amount detected by detection device 60 with the adjustment reference value and selectively adjust the flow rate for supplying aqueous phase 110 and the flow rate for supplying aqueous phase 150.

In the present exemplary embodiment, for example, the first reference value and the second reference value larger than the first reference value can be set in advance as the adjustment reference value. At this time, as illustrated in FIG. 4, step S103 may optionally include sub-steps S113, S123, S133, and S143.

In sub-step S113, the change amount of the detected characteristic amount is compared with the first reference value. When the change amount of the characteristic amount is less than the first reference value, the adjustment device is not operated, and the process proceeds to step S104. When the change amount of the characteristic amount is greater than or equal to the first reference value, the process proceeds to sub-step S123, and the change amount of the characteristic amount is further compared with the second reference value. When the change amount of the characteristic amount is less than the second reference value, the process proceeds to sub-step S133, and control device 80 operates the first adjustment device. For example, as illustrated in FIG. 2, command signal T1 is transmitted to flow rate regulator 71, and flow rate regulator 71 is operated to adjust the flow rate for supplying aqueous phase 110 based on the calculated correction amount. On the other hand, when the change amount of the characteristic amount is equal to or greater than the second reference value, the process proceeds to sub-step S143, and control device 80 operates the second adjustment device. For example, as illustrated in FIG. 2, command signal T2 is transmitted to flow rate regulator 72, and flow rate regulator 72 is operated to adjust the flow rate for supplying aqueous phase 150 based on the calculated correction amount. Transmission and reception of command signals T1 and T2 may be realized by wired connection or wireless transfer.

In this manner, by providing two adjustment reference values, comparing the change amount of the detected characteristic amount with the two adjustment reference values, and selectively adjusting the flow rate of aqueous phase 110 and the flow rate of aqueous phase 150, the amount of the aqueous phase introduced into the reaction unit can be adjusted more precisely. As a result, the reaction temperature in the polymerization liquid during the monomer polymerization reaction can be more stably maintained, and the stability of particle size control can be further improved.

(4) After step S103 is executed, the process proceeds to step S104. In step S104, it is determined whether or not the polymerization reaction is completed, and aqueous phase supply adjustment process S20 is repeatedly executed from step S101 to step S103 until the polymerization reaction is completed.

The amount of the aqueous phase introduced into reaction unit 40 of polymer particle producing device 100 during the monomer polymerization reaction can be adjusted by aqueous phase supply adjustment process S20 described above. The method for adjusting the amount of the aqueous phase introduced into the reaction unit through S101 to S104 is merely an example, and the adjustment of the amount of the aqueous phase introduced into the reaction unit during the monomer polymerization reaction is not limited to the process illustrated in FIG. 4.

For example, the flow rate for supplying aqueous phase 110 or aqueous phase 150 can be adjusted by manually operating the adjustment device based on the correction amount calculated in step S102 without executing step S103 illustrated in FIG. 4. In step S103, only one adjustment reference value can be used. At this time, control device 80 can operate flow rate regulator 71 or flow rate regulator 72 so as to adjust the flow rate for supplying aqueous phase 110 or aqueous phase 150 when the change amount of the detected characteristic amount becomes equal to or more than the set adjustment reference value.

By adjusting the amount of the aqueous phase introduced into the reaction unit during the monomer polymerization reaction in the polymer particle producing step by aqueous phase supply adjustment process S20, the reaction temperature in the polymerization liquid can be stabilized, and the stability of particle size control can be improved. This makes it possible to stably produce polymer particles having a desired particle size.

### EXAMPLES AND COMPARATIVE EXAMPLES

In Examples 1 to 3 and Comparative Example 1 in which the polymer particle polystyrene was produced, the effects of the polymer particle producing device and the polymer particle producing method of the present disclosure were verified. Hereinafter, Examples 1 to 3 and Comparative Example 1 will be described. However, the present disclosure is not limited to these examples or comparative examples at all.

### <Raw Materials>

In Examples 1 to 3 and Comparative Example 1, polymer particle polystyrene was produced using the following raw materials in common. Raw materials used in Examples 1 to 3 and Comparative Example 1 will be described with reference to polymer particle producing device 100 illustrated in FIG. 2.

Ultrapure water was used as aqueous phase 110 in storage unit 11 and aqueous phase 150 in storage unit 15. As surfactant 120 and monomer phase 130 in storage unit 12, a mixed solution of a 40 wt % aqueous surfactant (polyoxyalkylene alkyl ether) solution and a monomer (styrene monomer) was used. As initiator 140 in storage unit 14, an initiator aqueous solution prepared such that ammonium persulfate was 5.1 wt % in ultrapure water was used.

### <Production of Polystyrene Particles>

In Examples 1 to 3, polystyrene particles were produced using polymer particle producing device 100 of FIG. 2. Aqueous phase 110, surfactant 120, and monomer phase 130 were fed to flow path 21 and flow path 22 at a flow rate of 1:1 using a plunger pump, respectively, and joined in first mixer 31 to form a mixed solution, thereby preparing oil-in-water type emulsion 350. In the mixed solution, the surfactant concentration was 6.4 wt %. The mixed solution containing emulsion 350 was fed to flow path 51 at a flow rate of 30 mL/min.

Initiator 140 was fed to flow path 24 using a plunger pump, and joined with the mixed solution containing emulsion 350 in second mixer 32 to generate a polymerization liquid. In the polymerization liquid, the weight ratio of initiator 140 to the mixed solution containing the emulsion 350 was 0.023/l. The generated polymerization liquid was fed to flow path 52 at a flow rate of 31 mL/min.

As a flow path of polymer particle producing device 100, a PTFE tube having a flow path diameter of 1 mm was used. As first mixer 31 and second mixer 32, a T-shaped mixer made of SUS316 was used. The inner diameter of the T-shaped mixer was 0.5 mm.

The polymerization liquid was introduced into reaction tank 45 of reaction unit 40. Reaction tank 45 was composed of a screw tube having a capacity of 50 mL, and the temperature thereof was set so as to be constant at 70° C. The polymerization liquid in reaction tank 45 was held for 2 hours while being stirred at a rotation number of 400 rpm using a hot stirrer, and then the produced polystyrene particles were recovered.

### Example 1

As detection device 60, a vibration type viscometer was installed in the reaction tank, and when the viscosity of the detected polymerization liquid varied by 10% or more with respect to a predetermined viscosity reference value, the flow rate for supplying aqueous phase 110 was adjusted using the external control of the plunger pump (not illustrated) based on the calculated correction amount. At this time, the flow rate for supplying surfactant 120 and monomer phase 130 was maintained at 15 mL/min.

### Example 2

As detection device 60, a vibration type viscometer was installed in the reaction tank, and when the viscosity of the detected polymerization liquid varied by 10% or more with respect to a predetermined viscosity reference value, the flow rate for supplying aqueous phase 150 was adjusted using the external control of the plunger pump (not illustrated) based on the calculated correction amount. Other operations were the same as those in Example 1.

### Example 3

As detection device 60, a vibration type viscometer was installed in the reaction tank, and when the viscosity of the detected polymerization liquid varied from 10% to 20% with respect to a predetermined viscosity reference value, the flow rate for supplying aqueous phase 110 was adjusted based on the calculated correction amount. When a variation of 20% or more with respect to the predetermined viscosity reference value occurred, the flow rate for supplying aqueous phase 150 was adjusted based on the calculated correction amount. The adjustment device for adjusting the flow rate for supplying aqueous phase 110 had a flow rate adjustment accuracy of discharge accuracy ±1%, and the adjustment device for adjusting the flow rate for supplying aqueous phase 150 also had a flow rate adjustment accuracy of discharge accuracy ±1%. At this time, the flow rate for supplying surfactant 120 and monomer phase 130 was maintained at 15 mL/min.

### Comparative Example 1

In Comparative Example 1, polymer particle producing device 100 in FIG. 2 was used, and polystyrene particles were produced without supplying aqueous phase 150 and adjusting the flow rate for supplying aqueous phase 110. Other operations were the same as those in Example 1.

### <Evaluation of Particle Size Stability and Particle Yield>

In order to evaluate the particle size stability of the produced polystyrene particles, the particle size distribution was measured using a dynamic light scattering particle size distribution meter. The coefficient of variation (CV) of the particle size distribution is defined by the following equation in the average particle size (d) of the particles obtained by measurement and the standard deviation (SD) of the particle size distribution, and is obtained by measurement with a particle size distribution meter.

$$CV ( \% ) = 100 \times SD / d$$

The particle size stability of the produced polystyrene particles was evaluated in Examples 1 to 3 and Comparative Example 1. When the CV value of the produced polystyrene particles was less than 20%, it was evaluated as “high in particle size stability”, and when the CV value of the polystyrene particles was 20% or more, it was evaluated as “low in particle size stability”.

The particle yield of the polystyrene particles produced in Examples 1 to 3 and Comparative Example 1 was evaluated. The polystyrene particles were classified according to the particle size, and the proportion of particles having a particle size within a standard range of 200±100 nm among the produced polystyrene particles was calculated as a particle yield. A particle yield of 90% or more was evaluated as “very high particle yield”, a particle yield of 80% or more and less than 90% was evaluated as “high particle yield”, and a particle yield of less than 80% was evaluated as “low particle yield”.

In Examples 1 to 3 and Comparative Example 1, the evaluation results of the particle size stability and the particle yield for the produced polystyrene particles are shown in Table 1. In Table 1, the evaluation “high in particle size stability” is indicated by ◯, and the evaluation “low in particle size stability” is indicated by X. In addition, the evaluation “very high particle yield” is indicated by ⊙, the evaluation “high particle yield” is indicated by ◯, and the evaluation “low particle yield” is indicated by x.

TABLE 1

| | Evaluation of Particle | Evaluation of Particle |
|---|---|---|
| | Size Stability | Yield |
| Example 1 | ◯ | ◯ |
| Example 2 | ◯ | ◯ |
| Example 3 | ◯ | ⊙ |
| Comparative Example 1 | X | X |

In the particle size stability evaluation, as shown in Table 1, polystyrene particles having a stable particle size distribution were obtained in all of Examples 1 to 3. On the other hand, in Comparative Example 1, polystyrene particles having a stable particle size distribution were not obtained. In the production process of Comparative Example 1, it was found that blockage due to the solid content in the polymerization liquid occurred in a part of second mixer 32 and flow path 52 (see FIG. 2). As a result, an abnormal exothermic reaction occurred, and it is presumed that the produced polystyrene particles had a broad particle size distribution outside the standard range.

In addition, in the particle yield evaluation, as shown in Table 1, all of Examples 1 to 3 achieved high particle yields. On the other hand, in Comparative Example 1, the yield of polystyrene particles was low. Furthermore, a much higher particle yield was obtained in Example 3 than in Examples 1 to 2. In the production process of Example 3, the flow rate of aqueous phase 110 and the flow rate of aqueous phase 150 were selectively adjusted based on the variation of viscosity of polymerization liquid 450 detected by detection device 60. The polystyrene particles produced achieved a very high particle yield with a stable particle size distribution.

Advantageous effects of the polymer particle producing device and the polymer particle producing method of the present disclosure could be demonstrated in stably synthesizing particles having a desired particle size by the production of the polymer particle polystyrene according to Examples 1 to 3 and Comparative Example 1.

As described above, the accompanying drawings and the detailed description have been provided to describe the exemplary embodiment of the technique in the present disclosure. Thus, components described in the accompanying drawings and the detailed description may include not only components essential for solving the problem, but also components non-essential for solving the problem to describe the above techniques. For this reason, it should not be immediately recognized that these non-essential components are essential just because these non-essential components are described in the accompanying drawings and the detailed description.

According to the polymer particle producing device or the polymer particle producing method according to an aspect of the present disclosure, the stability of particle size control can be improved in the polymer particle production.

The present disclosure is applicable to polymer particle production, and is applicable to polymer particle production by an emulsion polymerization method. In addition, the present disclosure is applicable to production of polymer particles using a microreactor.

What is claimed is:

1. A polymer particle producing device for producing polymer particles by mixing an aqueous phase, a surfactant, and a monomer phase to prepare an oil-in-water emulsion and performing a monomer polymerization reaction using the prepared oil-in-water emulsion, the device comprising:
a supply unit including a flow path for supplying a first aqueous phase and a plurality of flow paths for supplying a surfactant, a monomer phase, and an initiator;
a mixing unit disposed on a downstream side of the supply unit and including
a first mixer that merges the first aqueous phase, the surfactant, and the monomer phase to prepare an emulsion and transfers the emulsion to a downstream side of the first mixer, and
a second mixer that merges the emulsion and the initiator to generate a polymerization liquid and transfers the polymerization liquid to a downstream side of the second mixer;
a reaction unit that is disposed on a downstream side of the mixing unit and causes a monomer polymerization reaction using the polymerization liquid; and
a flow path for supplying a second aqueous phase to the reaction unit.

2. The polymer particle producing device according to claim 1, further comprising:
a detection device that is disposed on a downstream side of the second mixer and detects a characteristic amount of the polymerization liquid; and
an adjustment device that adjusts an amount of an aqueous phase to be introduced into the reaction unit based on the detected characteristic amount.

3. The polymer particle producing device according to claim 2, further comprising a control device, wherein
the control device includes:
a processor; and
a storage device that stores an instruction to be executed by the processor,
the instruction calculates a correction amount with respect to a flow rate of supplying the aqueous phase to be introduced into the reaction unit based on the characteristic amount detected by the detection device, and
the adjustment device adjusts a flow rate for supplying the first aqueous phase or a flow rate for supplying the second aqueous phase based on the calculated correction amount.

4. The polymer particle producing device according to claim 3, wherein the instruction further includes operating the adjustment device to adjust the flow rate of supplying the first aqueous phase or the second aqueous phase based on the calculated correction amount.

5. The polymer particle producing device according to claim 4, wherein
the instruction includes:
operating the adjustment device to adjust the flow rate for supplying the first aqueous phase based on the calculated correction amount when a change amount of the detected characteristic amount with respect to a predetermined reference value is equal to or more than a first reference value and less than a second reference value; and
operating the adjustment device to adjust the flow rate for supplying the second aqueous phase based on the calculated correction amount when the change amount is equal to or more than the second reference value, and
the first reference value and the second reference value are preset adjustment reference values, and the second reference value is larger than the first reference value.

6. The polymer particle producing device according to claim 2, wherein the characteristic amount is absorbance or viscosity of the polymerization liquid.

7. The polymer particle producing device according to claim 1, wherein
the first mixer and the second mixer are configured by tubular flow paths, and
an inner diameter of each of the tubular flow paths ranges from 0.1 mm to 10 mm, inclusive.

8. The polymer particle producing device according to claim 1, wherein
the reaction unit includes a reaction tank, and
the monomer polymerization reaction is allowed to proceed in the reaction tank.

9. A polymer particle producing method, comprising:
producing an oil-in-water emulsion by joining a first aqueous phase, a surfactant, and a monomer phase in a flow path;
generating a polymerization liquid by joining the produced oil-in-water emulsion and an initiator, and subjecting the produced polymerization liquid to a monomer polymerization reaction in a reaction unit; and
supplying a second aqueous phase to the reaction unit.

10. The polymer particle producing method according to claim 9, further comprising:
detecting a characteristic amount of the polymerization liquid; and
adjusting an amount of an aqueous phase to be introduced into the reaction unit based on the detected characteristic amount.

11. The polymer particle producing method according to claim 10, wherein
adjusting the amount of the aqueous phase to be introduced into the reaction unit based on the detected characteristic amount includes:
calculating a correction amount with respect to a flow rate of supplying the aqueous phase to be introduced into the reaction unit based on the detected characteristic amount; and
operating an adjustment device to adjust a flow rate for supplying the first aqueous phase or a flow rate for supplying the second aqueous phase based on the calculated correction amount.

12. The polymer particle producing method according to claim 11, wherein
adjusting the amount of the aqueous phase to be introduced into the reaction unit based on the detected characteristic amount includes:
operating the adjustment device to adjust the flow rate for supplying the first aqueous phase based on the calculated correction amount when a change amount of the detected characteristic amount with respect to a predetermined reference value is equal to or more than a first reference value and less than a second reference value; and
operating the adjustment device to adjust the flow rate for supplying the second aqueous phase based on the calculated correction amount when the change amount is the second reference value or more, and
the first reference value and the second reference value are preset adjustment reference values, and the second reference value is larger than the first reference value.

13. A program for causing a processor to adjust an amount of an aqueous phase to be introduced into the reaction unit based on the detected characteristic amount in the polymer particle producing method according to claim 11.

14. A non-transitory computer readable storage medium storing the program according to claim 13.
